(19) United States
(12) Patent Application Publication
(10) Pub. No.: US 2008/0024405 A1
(43) Pub. Date: Jan. 31, 2008

(54) LIQUID CRYSTAL DISPLAY DEVICE AND METHOD OF DRIVING LIQUID CRYSTAL DISPLAY DEVICE

(76) Inventors: Tetsuo FUKAMI, Ishikawa-gun (JP); Yukio Tanaka, Kanazawa-shi (JP); Kenji Nakao, Kanazawa-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/781,441

(22) Filed: Jul. 23, 2007

(30) Foreign Application Priority Data
Jul. 25, 2006 (JP) 2006-202310

(51) Int. Cl. G09G 3/36

(52) U.S. Cl. 345/87

(57) ABSTRACT

A liquid crystal display device includes display pixels which are arrayed in a matrix, a driver circuit which drives the display pixels in units of a predetermined number of rows, and a controller which controls the driver circuit so as to alternately execute non-video signal write in which a non-video signal is written by driving the display pixels on a row-by-row basis, and video signal write in which a video signal is written by driving the display pixels on a row-by-row basis. Each of the display pixels includes a first capacitance which is formed by a voltage applied between electrode substrates, and a second capacitance which is coupled to the first capacitance. The controller includes a control circuit which controls the driver circuit so as to charge a predetermined capacitance on the second capacitance in a superimposing manner during a time period in which the non-video signal write is executed.

### CROSS-REFERENCE TO RELATED APPLICATIONS

This application is based upon and claims the benefit of priority from prior Japanese Patent Application No. 2006-202310, filed Jul. 25, 2006, the entire contents of which are incorporated herein by reference.

### BACKGROUND OF THE INVENTION

1. Field of the Invention

The present invention relates generally to a liquid crystal display device, and more particularly to an OCB mode liquid crystal display device and a method of driving the OCB mode liquid crystal display device.

2. Description of the Related Art

In recent years, liquid crystal display devices have been applied to various fields, such as personal computers, monitors, car navigation systems, scientific electric calculators and middle-sized and small-sized TVs.

In particular, in an OCB (Optically Compensated Bend) mode liquid crystal display device which is characterized by high-speed responsivity, a special driving scheme, such as a black-insertion driving scheme, needs to be used in order that the alignment state of liquid crystal molecules included in the liquid crystal layer may be kept in bend alignment. In the black-insertion driving scheme, a video signal and a black (non-video) signal are written in each pixel in every 1 frame (about 16.7 msec if the refresh rate is 60 Hz). In the OCB mode liquid crystal display device, such a driving scheme is adopted in order to maintain bend alignment and improve sharpness of motion video.

In the liquid crystal display device that adopts the black-insertion driving scheme, however, two different signals, i.e. a black signal and a video signal, have to be charged in each pixel during 1 frame. As a result, a decrease in black voltage occurs due to a difference in specific dielectric constant of the liquid crystal layer between a time of black signal display and a time of video signal display and a response speed of liquid crystal molecules. Specifically, in the case where the video signal is Vs, the dielectric constant of the liquid crystal layer at the time of video signal display is Es, the signal voltage at the time of black display is Vb and the dielectric constant at the time of black display is Eb, the charge Cs that is induced in the liquid crystal layer at the time of video signal display is proportional to Vs·Es.

If the black signal Vb is charged in the pixel electrode in this state, the dielectric constant after the charging of the pixel is kept not at Eb but at Es since the response of the liquid crystal is on the order of msec and is slow. Hence, immediately after the black signal is charged in the pixel, the charge Cb that is induced in the liquid crystal layer becomes Vb·Es.

Thereafter, since the liquid crystal molecules respond, the dielectric constant becomes Eb, but the voltage that is applied to the liquid crystal layer becomes Vb′=Vb·Es/Eb according to the theory of the retention of charge. Specifically, if the liquid crystal molecules are of n-type, the Eb at high voltage state is higher than Es, and thus, in some cases, the Vb′ becomes lower than Vb that has to be normally retained.

In the prior art, there has been proposed an OCB mode liquid crystal display device which is driven by superimposing, after a video signal is written via a signal line, a predetermined voltage on the video signal, thereby preventing reverse transition of the alignment state of the liquid crystal and reducing the influence of a decrease in screen brightness (see Jpn. Pat. Appln. KOKAI Publication No. 2004-46235).

According to this liquid crystal display device, however, since a predetermined voltage is superimposed on video signals that vary in accordance with respective associated pixels, some display pixels may not be fully charged and may fail to effect black display. As a result, in some cases, the contrast and brightness may decrease.

In particular, since this phenomenon becomes more conspicuous as the temperature of the environment becomes lower, there are cases in which degradation in optical characteristics of the liquid crystal display device, such as a decrease in contrast or brightness, may occur.

### BRIEF SUMMARY OF THE INVENTION

The present invention has been made in consideration of the above-described problems, and the object of the invention is to provide a liquid crystal display device which improves optical characteristics, for example, improves a decrease in contrast and brightness.

According to a first aspect of the invention, there is provided a liquid crystal display device comprising: a plurality of display pixels which are arrayed in a matrix; a driver circuit which drives the plurality of display pixels in units of a predetermined number of rows; and a controller which controls the driver circuit so as to alternately execute non-video signal write in which a non-video signal is written by driving the display pixels on a row-by-row basis, and video signal write in which a video signal is written by driving the display pixels on a row-by-row basis, wherein each of the plurality of display pixels includes a liquid crystal capacitance which is formed by a voltage that is applied between the electrode substrates, and a storage capacitance which is coupled to the liquid crystal capacitance, and the controller includes a control circuit which controls the driver circuit so as to charge a predetermined capacitance on the storage capacitance in a superimposing manner during a time period in which the non-video signal write is executed.

According to a second aspect of the invention, there is provided a driving method of a liquid crystal display device including: a plurality of display pixels which are arrayed in a matrix; a driver circuit which drives the plurality of display pixels in units of a predetermined number of rows; and a controller which controls the driver circuit, each of the plurality of display pixels including a liquid crystal capacitance which is formed by a voltage that is applied between electrode substrates, and a storage capacitance which is coupled to the liquid crystal capacitance, the method comprising: causing the controller to drive the driver circuit so as to alternately execute non-video signal write in which a non-video signal is written by driving the display pixels on a row-by-row basis, and video signal write in which a video signal is written by driving the display pixels on a row-by-row basis; and causing the controller to drive the driver circuit so as to charge a predetermined capacitance on the storage capacitance in a superimposing manner during a time period in which the non-video signal write is executed.

The present invention can provide a liquid crystal display device which improves optical characteristics, for example, improves a decrease in contrast and brightness.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows an example of the structure of a liquid crystal display device according to a first embodiment of the present invention;

FIG. 2 is a view for describing an example of the structure of each of display pixels of the liquid crystal display device according to the first embodiment of the invention;

FIG. 3 shows an example of driving waveforms of scanning lines and signal lines of the liquid crystal display device according to the first embodiment of the invention;

FIG. 4 shows an example of the structure of a liquid crystal display device according to a second embodiment of the present invention;

FIG. 5 is a view for describing an example of the structure of each of display pixels of the liquid crystal display device according to the second embodiment of the invention;

FIG. 6 shows an example of driving waveforms of scanning lines, signal lines and storage capacitance lines of the liquid crystal display device according to the second embodiment of the invention;

FIG. 7 is a view for describing another example of the structure of each of display pixels of the liquid crystal display device according to the second embodiment of the invention;

FIG. 8 shows another example of driving waveforms of scanning lines, signal lines and storage capacitance lines of the liquid crystal display device according to the second embodiment of the invention; and

FIG. 9 shows an example of driving waveforms in a conventional OCB mode liquid crystal display device.

### DETAILED DESCRIPTION OF THE INVENTION

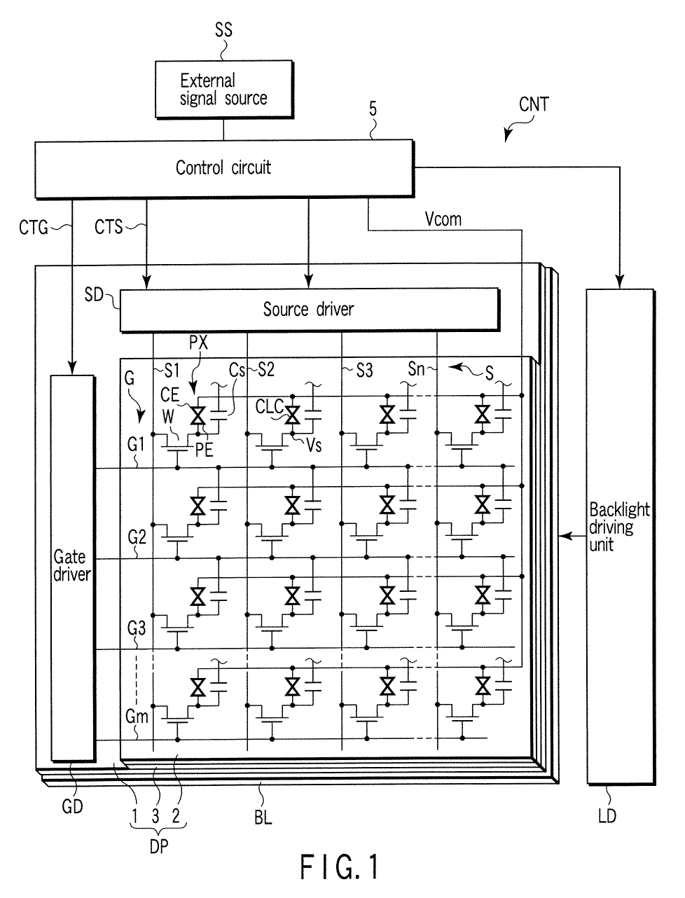

A liquid crystal display device according to a first embodiment of the present invention will now be described with reference to the accompanying drawings. FIG. 1 schematically shows a circuit structure of this liquid crystal display device. The liquid crystal display device includes an OCB mode liquid crystal display panel DP, a backlight BL which illuminates the liquid crystal display panel DP, and a controller CNT which controls the liquid crystal display panel DP and backlight BL.

The liquid crystal display panel DP includes a pair of electrode substrates, i.e. an array substrate 1 and a counter-substrate 2, and a liquid crystal layer 3 which is held between the array substrate 1 and counter-substrate 2. The liquid crystal layer 3 includes, as a liquid crystal material, a liquid crystal which is transitioned in advance, for example, from splay alignment to bend alignment in order to execute a normally-white display operation. In this embodiment, reverse transition of the liquid crystal from the bend alignment to splay alignment is prevented by cyclically applying a driving voltage corresponding to black display to the liquid crystal layer 3.

In addition, the liquid crystal display panel DP includes a display section which is composed of display pixels PX that are arrayed substantially in a matrix. The array substrate 1 includes a transparent insulating substrate which is formed of, e.g. glass. A plurality of pixel electrodes PE are disposed in association with the respective display pixels PX on the transparent insulating substrate.

Further, the array substrate 1 includes a plurality of scanning lines G (G1 to Gm) which are disposed along rows of the pixel electrodes PE, a plurality of signal lines S (S1 to Sn) which are disposed along columns of the pixel electrodes PE, and a plurality of pixel switches W which are disposed near intersections between the scanning lines G and signal lines S and permit, when driven via the associated scanning lines G, electrical conduction between the associated signal lines S and the associated pixel electrodes PE.

Each of the pixel switches W is composed of, e.g. a thin-film transistor. The gate of the thin-film transistor is connected to the scanning line G, and the source-drain path of the thin-film transistor is connected between the signal line S and the pixel electrode PE.

The counter-substrate 2 includes a color filter (not shown) which is formed of red, green and blue color layers disposed on a transparent insulating substrate of, e.g. glass, and a counter-electrode CE which is disposed on the color filter and is opposed to the plural pixel electrodes PE.

The pixel electrodes PE and counter-electrode CE are formed of a transparent electrode material such as ITO and are covered with alignment films, respectively, which are subjected to rubbing treatment in mutually parallel directions. Each pixel electrode PE and counter-electrode CE, together with a pixel region which is a part of the liquid crystal layer 3 that is controlled to have a liquid crystal molecular alignment corresponding to an electric field from the pixel electrode PE and counter-electrode CE, constitute the display pixel PX.

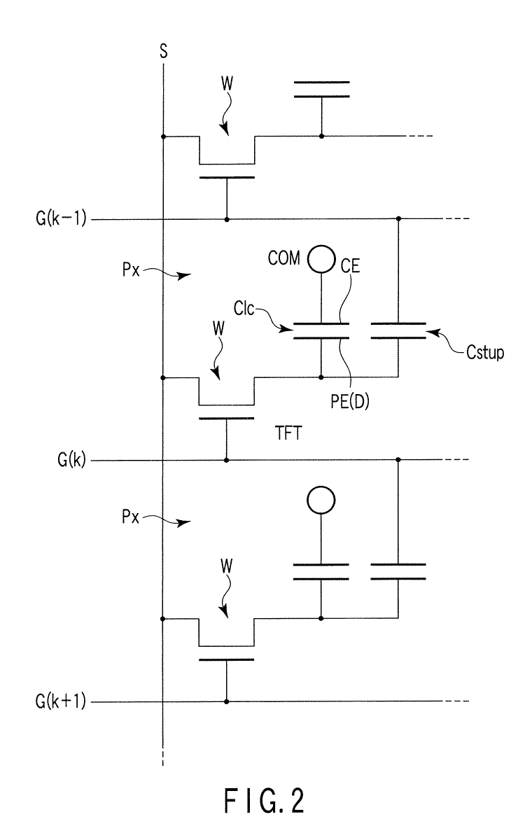

Each of the display pixels PX has a liquid crystal capacitance Clc between the associated pixel electrode PE and counter-electrode CE. In addition, a storage capacitance Cstup is constituted between the pixel electrode PE and the scanning line G that supplies a scanning signal to the display pixel PX disposed on the neighboring row. For example, in the case of FIG. 2, a storage capacitance is constituted between the pixel electrode PE, to which a voltage is applied from the scanning line G(k) via the pixel switch W, and the scanning line G(k−1) that applies a voltage to the pixel electrode PE of the display pixel PX disposed on the neighboring row.

The controller CNT includes a gate driver GD which successively drives the scanning lines G1 to Gm so as to turn on the plural pixel switches W on a row-by-row basis; a source driver SD which outputs pixel voltages Vs to the plural signal lines S1 to Sn during a time period in which the pixel switches W of each row are turned on by the driving of the associated scanning line G; a backlight driving unit LD which drives the backlight BL, and a control circuit 5 which controls the gate driver GD, source driver SD and backlight driving unit (inverter) LD.

The control circuit 5 is configured to execute an initializing process for transitioning liquid crystal molecules from splay alignment to bend alignment by varying a counter-voltage Vcom at a time of power-on and applying a relatively high driving voltage to the liquid crystal layer 3.

The control circuit 5 outputs to the gate driver GD a control signal CTG which is generated on the basis of a sync signal that is input from an external signal source SS. The control circuit 5 outputs to the source driver SD a control signal CTS which is generated on the basis of the sync signal that is input from the external signal source SS, and a video signal or a non-video signal for black insertion, which is input from the external signal source SS. Further, the control circuit 5 outputs a counter-voltage Vcom, which is to be applied to the counter-electrode CE, to the counter-electrode CE of the counter-substrate CT.

In the control circuit 5, a first period and a second period are set on the basis of the sync signal that is input from the external signal source SS. The first period is used in order to execute non-video signal write for writing a non-video signal, as a black-insertion signal, in the plural display pixels PX. The second period is used in order to execute video signal write for writing a video signal in the plural display pixels PX. The total time length of the first period and second period is one frame period or less.

The gate driver GD successively drives, under the control of the control signal CTG, the scanning lines G1 to Gm so as to successively select each row of display pixels PX for black insertion scan in the first period. The gate driver GD, in the second period following the first period, successively drives the scanning lines G1 to Gm so as to successively select each row of display pixels PX.

On the other hand, the source driver SD outputs non-video signals for one row as black-level pixel voltages Vs in the first period while each of the scanning lines G1 to Gm is being driven. Further, the source driver SD outputs video signals for one row as video-level pixel voltages Vs in the second period while each of the scanning lines Gl to Gm is being driven. As described above, the source driver SD drives the plural signal lines S1 to Sn in a parallel fashion.

The pixel voltages Vs for one row are applied to the pixel electrodes PE of the display pixels PX of the selected row via the corresponding pixel switches W. Thereby, the liquid crystal capacitance Clc is formed between the counter-electrode CE and the pixel electrode PE. The pixel voltages Vs for all the display pixels PX are set at opposite polarities on a pixel-column-by-pixel-column basis in the case of a column reverse driving scheme, and are set at opposite polarities on a frame-by-frame basis in the case of a frame reversal driving scheme.

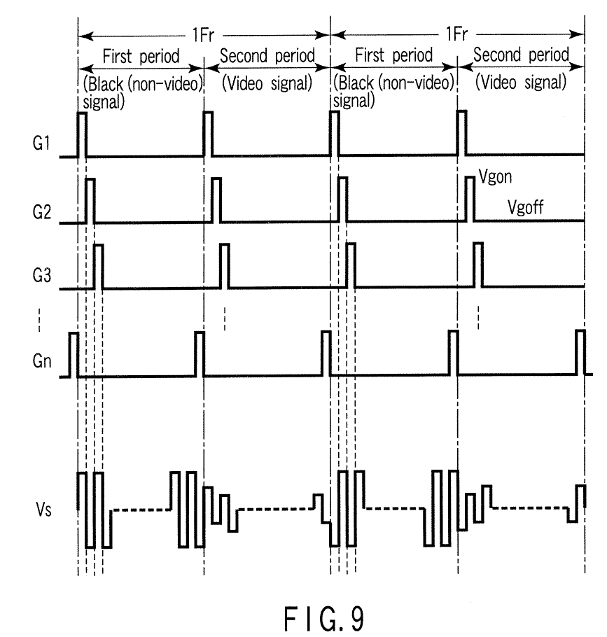

If black insertion driving is executed, for example, as shown in FIG. 9, a black-level voltage Vb and a video-level voltage are stored in the liquid crystal capacitance Clc as pixel voltages Vs in one frame period Fr, as described above. Specifically, pixel charging is executed twice in one frame period Fr. In this case, as described above, the liquid crystal application voltage Vlc (=|Vd−Vcom|) after the black insertion does not become a predetermined voltage Vb due to dielectric anisotropy, and becomes a voltage Vb′ that is lower than Vb.

To cope with this problem, in the liquid crystal display device according to the present embodiment, the control circuit 5 varies, while the black-level pixel voltage Vs is being applied to the pixel electrode PE of the display pixel PX, the voltage that is applied to the scanning line G which selectively drives the pixel electrode PE of the display pixel disposed on the neighboring row.

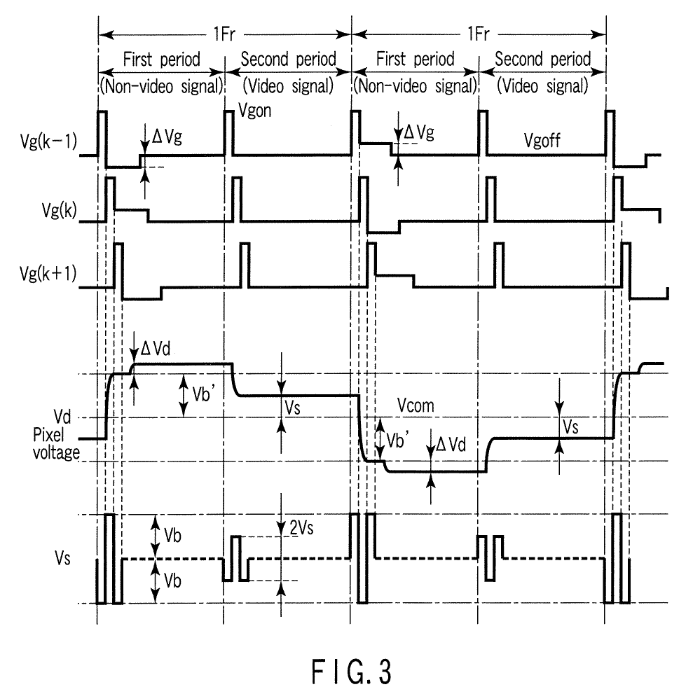

Specifically, as shown in FIG. 2 and FIG. 3, during the period (non-video signal write period) in which the black-level voltage Vb is applied as the pixel voltage Vs to the pixel electrode PE of the display pixel PX that is selectively driven by the scanning line G(k), the voltage that is applied to the scanning line G(k−1), which selectively drives the display pixels PX disposed on the neighboring row, is varied.

In this embodiment, as shown in FIG. 3, while the display pixel PX is being charged, the operation signal, which is input to the scanning line that selectively drives the display pixels PX disposed on the neighboring row, is varied by ΔVg, and the operation signal is varied by −ΔVg after the pixel charge. Thus, in the case shown in FIG. 2 and FIG. 3, when the scanning line G(k) is selectively driven and the non-video signal is applied to the display pixel PX that is selected by the signal line S, the operation signal that is applied to the scanning line G(k−1) is varied.

At this time, a signal that is varied from Vgoff by ΔVg (Vgoff−ΔVg in the case shown in FIG. 3) is applied to the scanning line G(k−1). If the charging of the display pixel PX of the row corresponding to the scanning line G(k) is completed, the signal that is applied to the scanning line G(k−1) varies by −ΔVg. In other words, the signal Vgoff is applied once again to the scanning line Gn-1.

Thus, in the liquid crystal display device according to the present embodiment, the storage capacitance Cstup is formed, as shown in FIG. 2, between the pixel electrode PE and the scanning line G(k-1) that successively drives the display pixel PX disposed on the neighboring row. Hence, by varying the voltage that is applied to the scanning line G(k-1) as described above, a predetermined capacitance is charged in the storage capacitance Cstup. Specifically, since the storage capacitance Cstup is coupled to the liquid crystal capacitance Clc, the liquid crystal capacitance Clc can be charged in a superimposing manner. Therefore, a deficiency in voltage at the time of black insertion can be compensated, and the pixel potential D after the black insertion can be prevented from decreasing to a predetermined potential Vb or less.

At this time, in the case where the display pixel has a positive polarity relative to the counter-voltage Vcom, the value of ΔVg is a negative value. On the other hand, in the case where the display pixel has a negative polarity relative to the counter-voltage Vcom, the value of ΔVg is a positive value. Since a drop in black voltage increases due to dielectric anisotropy as the temperature becomes lower, the voltageΔVd that is superimposed on the pixel voltage should better be increased by increasing the variationΔVg of the gate voltage.

In short, the present embodiment can provide a liquid crystal display device which improves optical characteristics, for example, improves a decrease in contrast and brightness.

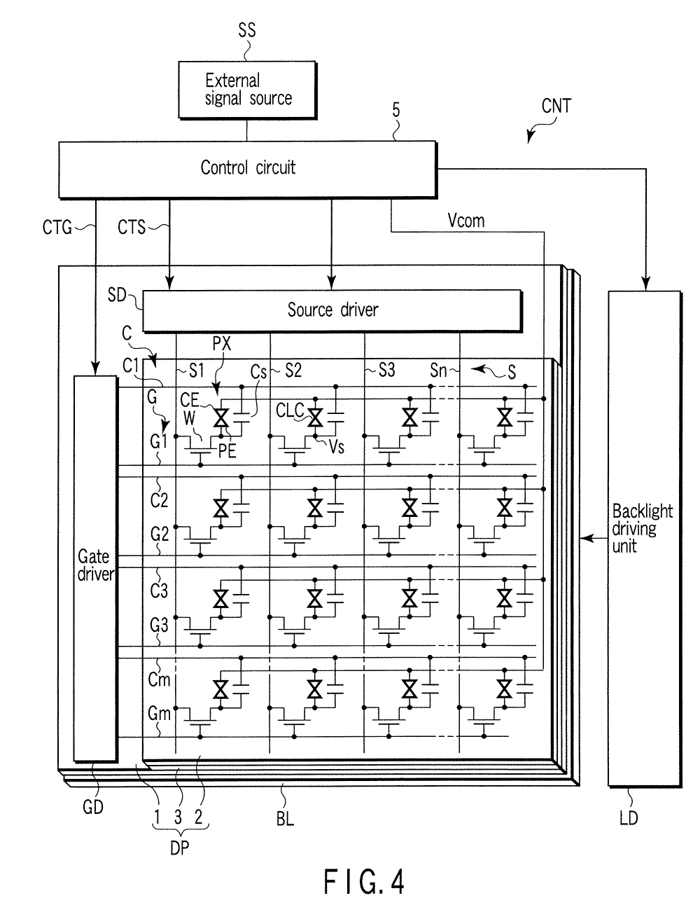

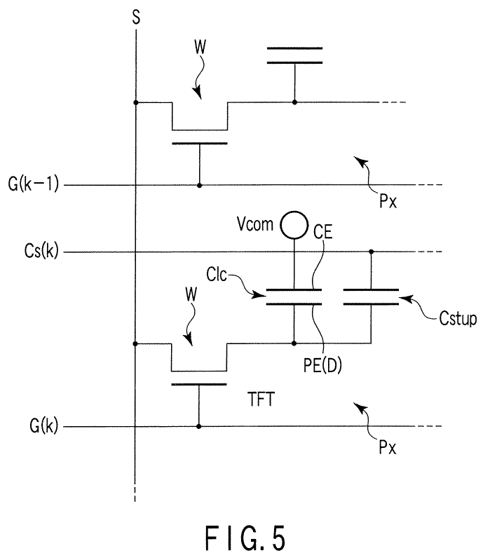

Next, a second embodiment of the present invention will now be described with reference to the accompanying drawings. In the description below, the structural parts common to those of the liquid crystal display device according to the first embodiment are denoted by like reference numerals, and a description of the common parts is omitted. As is shown in FIG. 4 and FIG. 5, in this embodiment, the array substrate 1 includes storage capacitance lines Cs (Cs1 to Csm). Each of the storage capacitance lines Cs1 to Csm is capacitive-coupled to the pixel electrode PE of the display pixels PX of the row, thereby forming the storage capacitance Cstup.

Therefore, in the present embodiment, as shown in FIG. 5, when the black signal (non-video signal) Vb is charged in the pixel electrode PE as the pixel voltage Vs, the storage capacitance voltage is varied. The storage capacitance voltage that is applied to the storage capacitance line is varied by ΔVst before and after the pixel charging, that is, before the timing at which the signal applied to the scanning line G is set at Vgon and after the timing at which the signal applied to the scanning line G is set at Vgoff.

For example, in the case shown in FIG. 5, the voltage applied to the storage capacitance line Cs(k) is varied by +ΔVst before the voltage applied to the scanning line G(k) is set at Vgon, and the voltage applied to the storage capacitance line Cs(k) is varied by −ΔVst after the voltage applied to the scanning line G(k) is set at Vgoff.

Specifically, like the first embodiment, the storage capacitance Cstup is coupled to the liquid crystal capacitance Clc. Thus, like the above-described case, when the non-video signal is charged in the pixel electrode PE, the liquid crystal capacitance Clc can be charged in a superimposing manner by varying the voltage that is applied to the storage capacitance line Cs. Therefore, a deficiency in voltage at the time of black insertion can be compensated, and the pixel potential D after the black insertion can be prevented from decreasing to a predetermined potential Vb or less.

Specifically, according to the liquid crystal display device of the above-described embodiment, since a predetermined storage capacitance is superimposed on the liquid crystal capacitance Clc via the storage capacitance line Cs, the potential ΔVd can be superimposed on the pixel potential D without increasing the load on the scanning line G, and the same advantageous effects as in the liquid crystal display device of the first embodiment can be obtained.

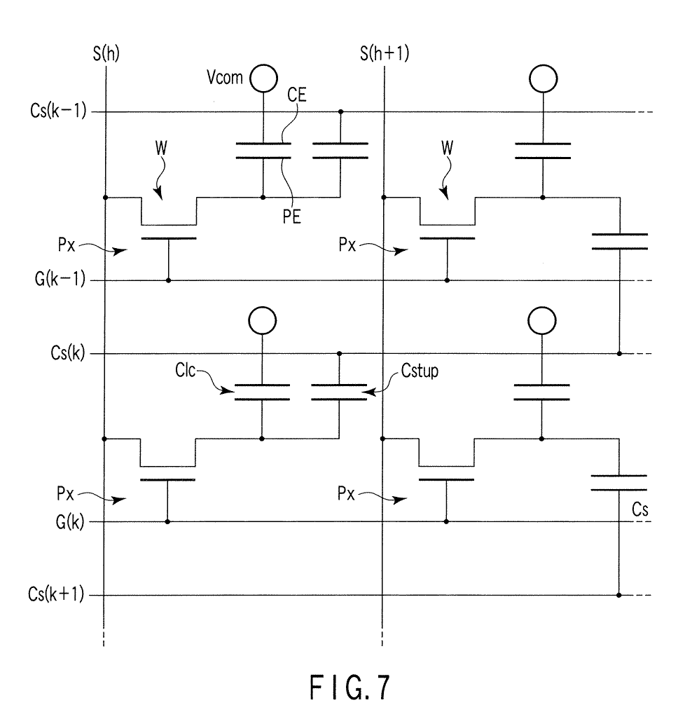

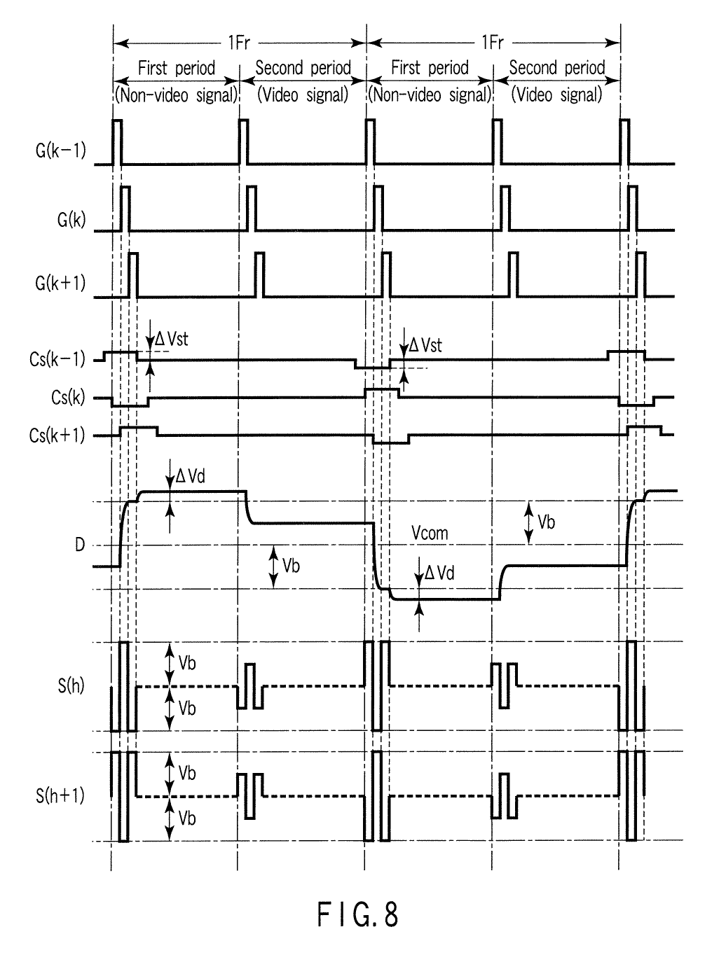

Furthermore, in a case shown in FIG. 7 and FIG. 8, in mutually neighboring display pixels, storage capacitances Cstup are formed between different storage capacitance lines Cs and the pixel electrodes PE. For example, as shown in FIG. 7, in a given display pixel PX, a storage capacitance Cstup is formed between the pixel electrode PE and the storage capacitance line Cs(k−1). In a neighboring display pixel PX, a storage capacitance Cstup is formed between the pixel electrode PE and the storage capacitance line Cs(k).

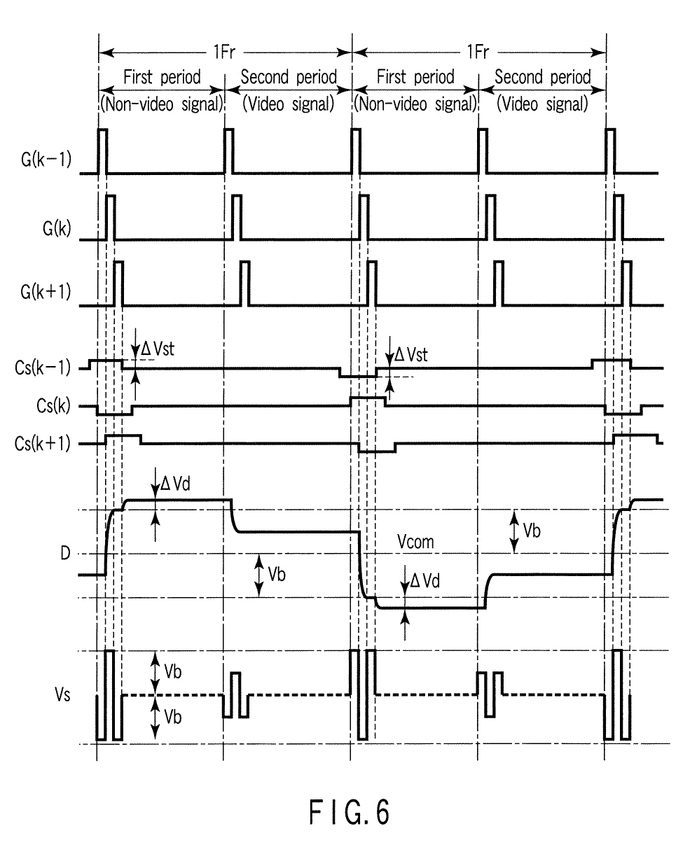

If the storage capacitances Cstup are formed as described above, potentials of opposite polarities, relative to the counter-voltage Vcom, can be charged in the display pixels PX connected to the same scanning line G. Thereby, the same advantageous effects as in the case of FIG. 5 and FIG. 6 can be obtained, and flicker can be reduced.

The present invention is not limited directly to the above-described embodiments. In practice, the structural elements can be modified without departing from the spirit of the invention.

For example, in the above-described embodiments, when non-video signal write is executed, the scanning lines G are driven one by one. Alternatively, non-video signal write may be executed by driving a plurality of scanning lines G at the same time.

Various inventions can be made by properly combining the structural elements disclosed in the embodiments. For example, some structural elements may be omitted from all the structural elements disclosed in the embodiments. Furthermore, structural elements in different embodiments may properly be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device comprising:
a pair of electrode substrates which are disposed to be opposed to each other;
a liquid crystal layer which is held between the pair of electrode substrates;
a plurality of display pixels which are arrayed in a matrix;
a driver circuit which drives the plurality of display pixels in units of a predetermined number of rows; and
a controller which controls the driver circuit so as to alternately execute non-video signal write in which a non-video signal is written by driving the display pixels on a row-by-row basis, and video signal write in which a video signal is written by driving the display pixels on a row-by-row basis,
wherein each of the plurality of display pixels includes a liquid crystal capacitance which is formed by a voltage that is applied between the electrode substrates, and a storage capacitance which is coupled to the liquid crystal capacitance, and
the controller includes a control circuit which controls the driver circuit so as to charge a predetermined capacitance on the-storage capacitance in a superimposing manner during a time period in which the non-video signal write is executed.

2. The liquid crystal display device according to claim 1, further comprising:
a scanning line disposed along a row of the plurality of display pixels; and
a signal line disposed along a column of the plurality of display pixels,
wherein the storage capacitance is formed between a pixel electrode, which is provided in each of the plurality of display pixels, and the scanning line which supplies a scanning signal to the liquid crystal capacitance of the display pixel disposed on a neighboring row.

3. The liquid crystal display device according to claim 1, further comprising:
a scanning line disposed along a row of the plurality of display pixels; and
a signal line disposed along a column of the plurality of display pixels; and
a storage capacitance line disposed substantially parallel to the scanning line,
wherein the storage capacitance is formed by a pixel electrode, which is provided in each of the plurality of display pixels, and the storage capacitance line.

4. The liquid crystal display device according to claim 3, wherein the storage capacitances of neighboring said display pixels are formed by the pixel electrodes, which are disposed in the respective display pixels, and voltages which are applied to mutually different said storage capacitance lines.

5. A driving method of a liquid crystal display device including:
a pair of electrode substrates which are disposed to be opposed to each other;
a liquid crystal layer which is held between the pair of electrode substrates;
a plurality of display pixels which are arrayed in a matrix;
a driver circuit which drives the plurality of display pixels in units of a predetermined number of rows; and
a controller which controls the driver circuit, each of the plurality of display pixels including a liquid crystal capacitance which is formed by a voltage that is applied between the electrode substrates, and a storage capacitance which is coupled to the liquid crystal capacitance, the method comprising:
causing the controller to drive the driver circuit so as to alternately execute non-video signal write in which a non-video signal is written by driving the display pixels on a row-by-row basis, and video signal write in which a video signal is written by driving the display pixels on a row-by-row basis; and
causing the controller to drive the driver circuit so as to charge a predetermined capacitance on the storage capacitance in a superimposing manner during a time period in which the non-video signal write is executed.

6. The driving method of a liquid crystal display device according to claim 5, wherein the liquid crystal display device further includes a scanning line disposed along a row of the plurality of display pixels, and a signal line disposed along a column of the plurality of display pixels, and
the controller applies a predetermined voltage to the scanning line which supplies a scanning signal to the liquid crystal capacitance of the display pixel disposed on a neighboring row, thereby charging a predetermined capacitance on the storage capacitance in a superimposing manner during a time period in which the non-video signal write is executed.

7. The driving method of a liquid crystal display device according to claim 5, wherein the liquid crystal display device further includes a scanning line disposed along a row of the plurality of display pixels, a signal line disposed along a column of the plurality of display pixels, and a storage capacitance line which is disposed substantially parallel to the scanning line and forms the storage capacitance between the storage capacitance line and a pixel electrode disposed in each of the display pixels,
wherein the controller applies a predetermined voltage to the storage capacitance line, thereby charging a predetermined capacitance on the storage capacitance in a superimposing manner during a time period in which the non-video signal write is executed.
